(19) United States
(12) Patent Application Publication
(10) Pub. No.: US 2025/0320001 A1
(43) Pub. Date: Oct. 16, 2025

(54) Stabilized Measurement Module Couplable to Drones and Portable Stabilizers for Linear Measurement and Identification of Inclination of Structures

(71) Applicant: PETRÓLEO BRASILEIRO S.A. - PETROBRAS, Rio de Janeiro (BR)

(72) Inventors: Renato Faustino, Santos (BR); Ricardo Bonetti, Santos (BR)

(73) Assignee: PETRÓLEO BRASILEIRO S.A. - PETROBRAS, Rio de Janeiro, RJ (BR)

(21) Appl. No.: 19/178,516

(22) Filed: Apr. 14, 2025

(30) Foreign Application Priority Data
Apr. 15, 2024 (BR) 2020240072605

(51) Int. Cl. B64U 20/80; G01B 11/06; G01B 11/26; G01C 5/02; G01C 9/00; G01D 11/24

(52) U.S. Cl. CPC B64U 20/80; G01B 11/0608; G01B 11/26; G01C 5/02; G01C 9/005; G01D 11/245

(57) ABSTRACT

The present disclosure refers to a measurement and stabilization module couplable to drones and portable stabilizers for linear measurement and identification of inclination of structures. This module comprises: a telemetric housing, subdivided into: a front portion, a lower portion, a rear portion, a right side portion and a left side portion; a protective cage; rods of a gimbal; four engagement elements and four engagement rotation elements.

### CROSS-REFERENCE TO RELATED APPLICATIONS

This application claims priority to Brazilian Application No. BR2020240072605 filed on Apr. 15, 2024, the disclosure if which is expressly incorporated herein by reference in its entirety.

### FIELD OF THE DISCLOSURE

The present disclosure is part of the technical field of dimension measurement systems, especially applied to drones. Specifically, the invention is intended to facilitate linear measurements and identify the inclination of structures using drones equipped with the stabilized measurement module.

### BACKGROUNDS OF THE DISCLOSURE

The backgrounds of the disclosure bring to light several common technical problems related to the measurement of dimensions in structures, especially when linear measurements are necessary.

One of these problems known in the state of the art is the dependence on fixed or known references, which could lead to errors if the reference is not precise or changes throughout the execution of the activity. In addition, there is a risk of accidents when taking measurements on tall structures, such as towers or buildings, since processes such as climbing can involve high levels of risk for the operators responsible for the measurement.

Another limitation of the methodologies in the state of the art is the precision of the measurements, which can be affected by variations in the construction of the structures or in the measurement techniques used. In addition, the access to risk areas to take measurements can also be a challenge.

These problems highlight the need for a solution that increases the precision and efficiency of the linear measurements, reduces human error and allows the access to risk areas without exposing operators to unnecessary risks.

Document CN108303703A refers to a laser measurement system coupled to a drone to monitor the height of buildings on a construction site. The system uses a drone with specific components, including a main body, motors, position sensors, a measuring laser mounted on a specific base and a chassis. The drone is remotely controlled to take measurements of the height of the structures.

However, unlike document CN108303703A, the present disclosure is equipped with a gimbal, dispensing with the use of multiple rotors, which implies that changes in the wind, for example, would have a much smaller impact on the taken measurements. In addition, the present disclosure presents a quick connector mechanism for attachment to the skis or rods that support the drone motors, consisting of four attachment points that attach to the ski handle or rods, which is not described by document CN 108303703A.

Document CN211553794U refers to a data control measurement and processing device for a non-contact quality detection system for the outer layer of building walls. It aims at solving technical problems in detecting defects such as cracks, thermal bridges and detachment of the coating on the surface of the outer walls.

However, document CN211553794U fails to present a measurement and stabilization module, as it is not couplable to commercial drones. The present disclosure is couplable to commercial drones and portable stabilizers presenting a quick connector mechanism for attachment to skis or rods of the motors when used with a drone, consisting of four attachment points that attach to the ski handle or to the rods of the motors, in addition to having a protective cage for its telemetric structure, which also provides landing and take-off stability when coupled to the drone.

In view of this, the present disclosure offers a safer and more stable solution for performing measurements using drones, drastically reducing the errors associated with alternatives of the state of the art.

### SUMMARY OF THE DISCLOSURE

The present disclosure addresses to a stabilized measurement module couplable to drones and portable stabilizers for linear measurement and identification of inclination of structures. This module comprises: a telemetric housing, subdivided into: a front portion, a lower portion, a rear portion, a right side portion and a left side portion; a protective cage; rods; gimbal; four engagement elements.

The telemetric housing has four laser pointers, two of which are in its lower portion and two more in the front portion; two rangefinders, one of which is in its lower portion and the other in its front portion; two displays, one of which is in its front portion and the other in its rear portion; three points for coupling rods of the gimbal, one of which is in its rear portion, and the others symmetrically opposite in their side portions; a USB-C input in its rear portion; an LED in its rear portion; and an on/off button in its right side portion.

Additionally, it should be highlighted that the telemetric housing is coupled to a protective cage, by means of three rods of the gimbal, attached to at the three coupling points.

### BRIEF DESCRIPTION OF THE DRAWINGS

The present disclosure will be described below with reference to the typical embodiments of the same and with reference to the appended drawings, in which:

FIG. 1 is a representation of different views of the telemetric housing of the present disclosure.

FIG. 2 is a representation of the side and front views of the present disclosure coupled to a drone.

FIG. 3 is a representation of an exemplary embodiment of the present invention for measuring the drone height with rangefinder precision.

FIG. 4 is a representation of an exemplary embodiment of the present invention for measuring the height with a horizontal reference point.

FIG. 5 is a representation of an exemplary embodiment of the present invention for indicating the inclination of structures.

### DETAILED DESCRIPTION OF THE DISCLOSURE

The present disclosure addresses to a module designed with the purpose of improving the measurement capabilities using drones, making them versatile instruments for applications in various areas. It consists of several integrated parts that perform specific functions to ensure precise and stable measurements.

Among the components of the module, the following items stand out:
Gimbal: Responsible for stabilizing the module during the drone flight, minimizing the transfer of movements and ensuring precise measurements;
Rangefinder: Equipment used to measure the distance between the module and the target object, allowing linear measurements to be made;
Laser Pointer: Used to indicate the point to be measured by the rangefinder, with configurable power;
Protective Cage: External structure of the module that surrounds the telemetric components, providing stability during landing and takeoff of the drone and protecting the internal components against damage;
Quick Connector Mechanism: Allows the module to be attached to the skis or rods of the motors of the drone quickly and safely, ensuring a stable connection during the flight; and
Display: Shows the height measured by the rangefinder, configuration items and internal battery status.

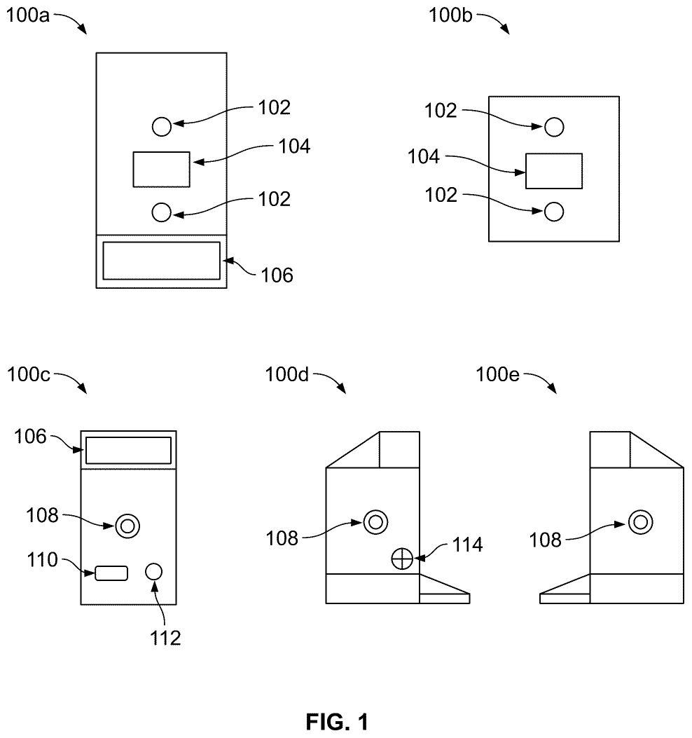

As can be seen in more detail in the different views represented in FIG. 1, the telemetric housing can be subdivided into: front portion (100a), lower portion (100b), rear portion (100c), right side portion (100d) and left side portion (100e).

This telemetric housing comprises the following structures: four laser pointers (102), two of which are in its lower portion and two more in its front portion; two rangefinders (104), one of which is in its lower portion and the other in its front portion; two displays (106), one of which is in its front portion and the other in its rear portion; three points for coupling (108) of rods of the gimbal, one of which is in its rear portion, and the others symmetrically opposed in their side portions; a USB-C input (110) in its rear portion; an LED (112) in its rear portion; and an on/off button (114) in its right side portion.

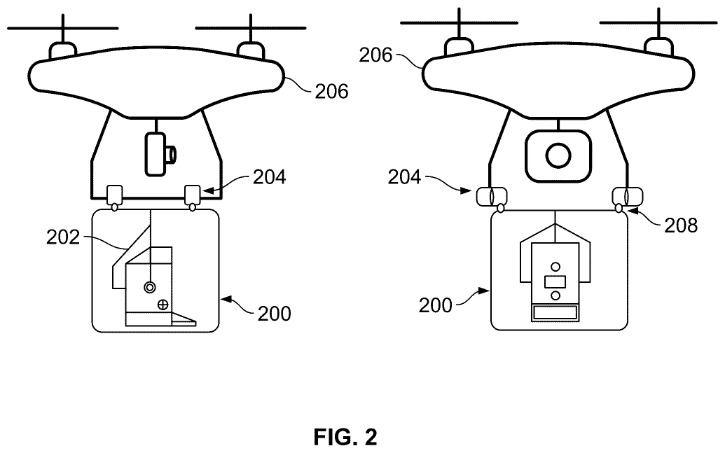

As can be seen in more detail in FIG. 2, the telemetric housing is coupled to a protective cage (200), by means of three rods of the gimbal (202), attached to at the three coupling points (108).

The rods of the gimbal (202) join and connect to the upper portion of the protective cage (200). Additionally, to quickly connect and attach the protective cage (200) to the skis of the drone (206), the protective cage (200) has two engagement elements (204) and two engagement rotation elements (208), which allow the engagement to rotate, adapting to different drone models. Alternatively, the solution can be attached to the support rods of the drone motors.

### EXAMPLES OF USE

In order to better exemplify possible uses for the measurement and stabilization module of the present disclosure, some hypothetical situations and different applications will be mentioned, without being limited to the same.

### Example 1—Height Measurement With Only the Lower Portion

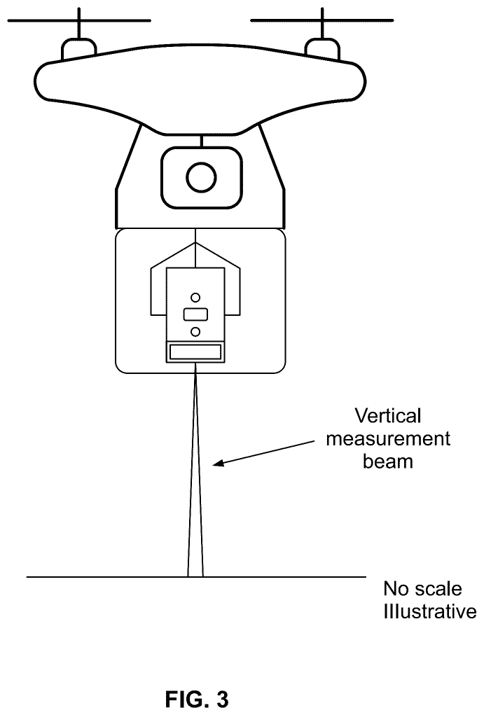

In this case, represented by FIG. 3, the gimbal minimizes the transfer of movements from the drone to the telemetry housing. Once activated with power compatible with the height, the user can identify the point at which the laser pointer beam falls to the point to be measured. In turn, the rangefinder will record the height to which it is directed. The display then shows the height measured by the rangefinder. This measurement can be viewed on the display by the drone camera. Once positioned, in a situation where the module does not have the information integrated with the drone platform, by pointing the drone camera at the display it is possible to view the height recorded by the rangefinder in the application that controls the drone on the operator's remote control.

### Example 2—Height Measurement With Lower and Front Portions

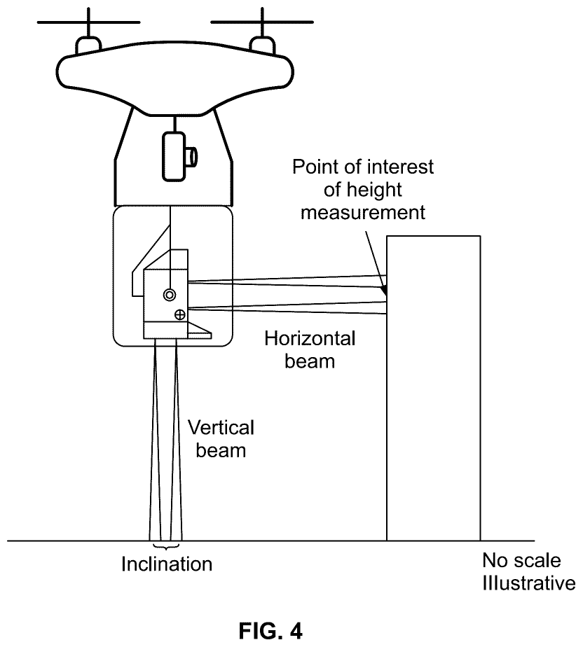

FIG. 4 demonstrates how height can be measured in a case where the beam of the laser pointers in the front portion is used to indicate a given measurement point horizontally. For a precise measurement, it is necessary to consider the vertical distance between the beam of the laser pointers in the lower and front portions.

In this situation, it is possible to use the drone camera to view the point of incidence of the horizontal laser. The height measurement follows the same logic as in example 1.

### Example 3—Identifying the Inclination of Structures

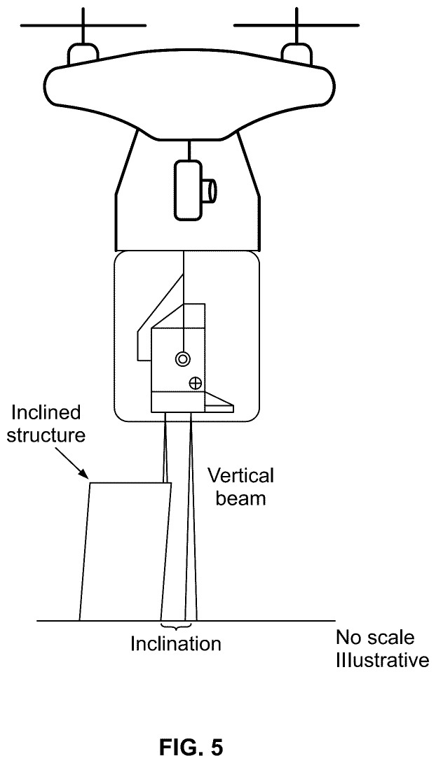

FIG. 5 demonstrates a way to identify the inclination of a given structure. Once activated with power compatible with the height, the drone operator uses the camera to identify the incidence of one of the beams on the upper part of the structure. When positioning the drone, it is possible to view the distance between the base of the structure and the laser beam that is falling in its vicinity. The inclination value can be calculated as the distance from the base in relation to the beam, minus the distance between the vertical laser beams.

In this way, it is apparent that the approach proposed by the present disclosure aims at offering a series of significant advantages compared to the traditional measurement methods.

The integration of technologies such as the gimbal, rangefinder and laser pointer allows for precise and stable measurements, reducing the occurrence of errors and ensuring reliable results. In addition, the modular design and quick connector mechanism facilitate the installation and removal of the module in commercial drones, increasing the flexibility and adaptability of the system for different scenarios and drone models. The ability to perform measurements in difficult-to-access or dangerous areas, without the need to expose operators to risks, is another significant advantage, ensuring the safety and efficiency of operations. Furthermore, the ability to view and record measurements in real time, by means of the integrated display, provides an intuitive and effective user experience.

Together, the advantages described herein highlight the contribution of the disclosure to optimizing measurement processes in various applications, offering greater precision, safety and practicality for performing linear measurements.

What is claimed is:

1. A stabilized measurement module couplable to drones and portable stabilizers for linear measurement and identification of inclination of structures comprising:
a telemetric housing, subdivided into: a front portion, a lower portion, a rear portion, a right side portion and a left side portion;
a protective cage;
rods of a gimbal; and
four engagement elements and four engagement rotation elements.

2. The module according to claim 1, wherein the telemetric housing comprises:
four laser pointers, two of them in its lower portion and two more in the front portion;
two rangefinders, one of which is in its lower portion and the other in its front portion;
two displays, one of which is in its front portion and the other in its rear portion;
three points for coupling of rods of the gimbal, one of which is in its rear portion, and the others symmetrically opposite in their side portions;
a USB-C input in its rear portion;
an LED in its rear portion; and
an on/off button in its right side portion.

3. The module according to claim 1, wherein the telemetric housing is coupled to a protective cage, by means of three rods of the gimbal, attached to at the three coupling points.

4. The module according to claim 3, wherein it can be used to perform height and inclination measurements of structures.
